(19) United States
(12) Patent Application Publication
(10) Pub. No.: US 2006/0027975 A1
(43) Pub. Date: Feb. 9, 2006

(54) Sealing device for contact rolling bearings

(75) Inventors: Angelo Vignotto, Torino (IT); Claudio Savarese, Airasca (IT); Domenico Bosco, Vibo Valentia (IT)

Correspondence Address: MERCHANT & GOULD PC, P.O. BOX 2903, MINNEAPOLIS, MN, 55402-0903, US

(73) Assignee: Aktiebolaget SKF, Goteborg (SE)

(21) Appl. No.: 11/185,189

(22) Filed: Jul. 19, 2005

(30) Foreign Application Priority Data
Jul. 23, 2004 (IT) TO2004A000511

(51) Int. Cl. F16J 15/34

(52) U.S. Cl. 277/402

(57) ABSTRACT

A seal (1) for rolling-contact bearings, the seal (1) being mounted between an outer race (4) and an inner race (3) of the bearing (2), and being provided with a first shield (20) fitted on the inner race (3), with a second shield (30) fitted on the outer race (4), and with a single lip seal fixed to the second shield (30) and set in sliding contact with the first shield (20); the first shield (20) having a contact wall (22) with a toroidal shape set up against the sealing lip (40), which is in turn provided with at least two contacting annular portions (42, 44) acting in substantially opposite radial directions, and with a cove of separation (43) between the at least two contacting portions (42, 44), which is elastically deformable to increase a contacting action of the contacting portions (42, 44) themselves on the contact wall (22).

The present invention relates to a sealing device for rolling-contact bearings.

In general, sealing devices of a known type are mounted between an outer race and an inner race of the bearing in order to prevent entry of contaminating agents within the bearing and exit of lubricating grease from the bearing, and comprise a first shield fitted on the inner race, a second shield fitted on the outer race, and a seal element fixed to the second shield and set in sliding contact with the first shield.

In sealing devices of the type described above, the first shield comprises a cylindrical wall fitted on the inner race and a flange fixed to the cylindrical wall and extending radially in the direction of the outer race, whilst A sealing device element is defined by: a contacting lip set against the cylindrical wall; a contacting appendage fixed to the lip and set up against the flange; and a spring applied on the contacting lip to increase the force of pressure thereof on the cylindrical wall, i.e., to increase the sealing effect.

Sealing devices of the type described above have for a long time proven absolutely reliable; however, current technical solutions in the field of rolling-contact bearings increasingly require a reduction in the axial dimensions of these devices, as well as a reduction in the numbers of components in order to reduce also the production costs.

In addition, the need to provide sealing devices of the type described above with a phonic wheel for acquisition of the kinematic data of the bearing has led to certain other complications both during assembly of the bearings and during construction of the sealing devices themselves.

In fact, the introduction of a phonic wheel in the sealing devices involves either an increase in the overall axial dimensions of the sealing device itself in contrast with the aforementioned needs of current technical solutions in the field of rolling-contact bearings, or else, given the same axial dimensions, a greater deformation of the seal element with a consequent sensible reduction in the sealing capacity of the sealing devices themselves.

In addition, since each rolling-contact bearing is normally provided, on the respective two axial sides, with as many sealing devices, the presence or otherwise of the phonic wheel renders necessary the provision of two sealing devices that are substantially different from one another not only as regards their geometrical characteristics but also as regards systems of assembly, with a consequent increase in the production costs.

The purpose of the present invention is to provide a sealing device for rolling-contact bearings which can be indifferently provided or not with a phonic wheel and will enable, at the same time, not only the guarantee of high sealing standards both in regard to external contaminating agents and to internal lubricating greases but also a reduction in the number of components and in the number of operations and amount of equipment and instrumentation necessary for its assembly.

According to the present invention, a sealing device for rolling-contact bearings is provided, said sealing device being mounted between an outer race and an inner race of the bearing and comprising a first shield fitted on the inner race, a second shield fitted on the outer race, and a seal element fixed to the second shield and set in sliding contact with the first shield, the sealing device being characterized in that the first shield comprises a contact wall having a toroidal shape set up against said seal element, which, in turn, comprises at least two annular contacting portions acting in substantially opposite radial directions and is provided with a cove of separation between the at least two elastically deformable contacting portions to increase a contacting action of the contacting portions themselves on the contact wall.

The invention will now be described with reference to the annexed plate of drawings, which illustrate a non-limiting example of embodiment thereof, and in which:

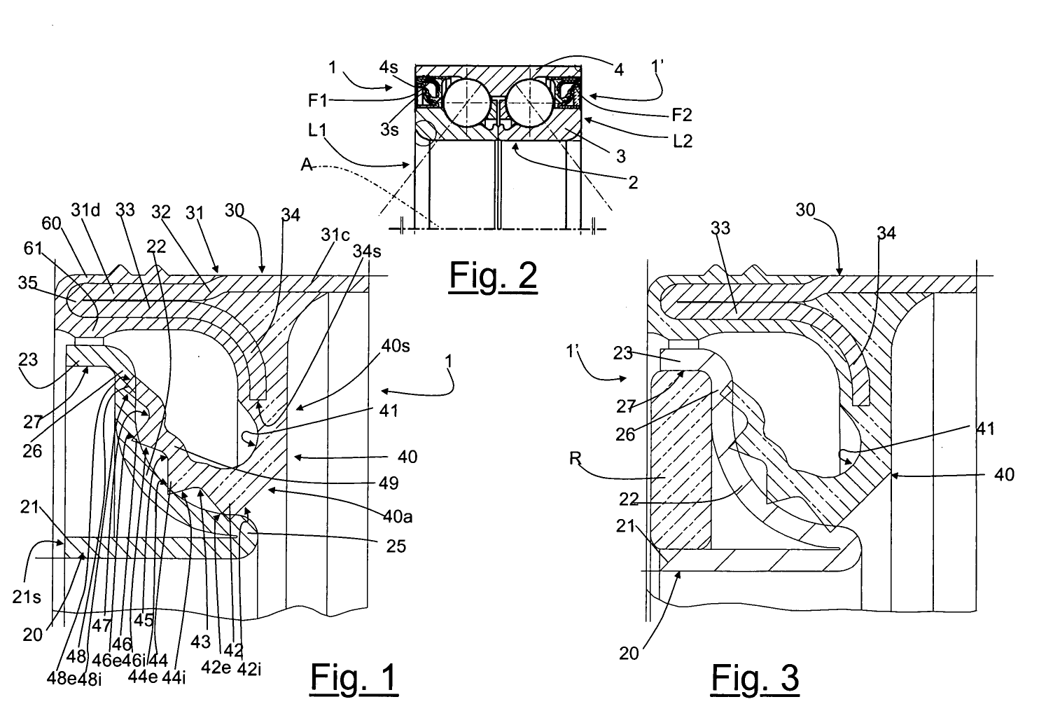

FIG. 1 is an axial cross-sectional view of a first preferred embodiment of a sealing device for rolling-contact bearings made according to the present invention;

FIG. 2 is an axial cross-sectional view of a second preferred embodiment of the sealing device of FIG. 1; and

FIG. 3 is an axial cross-sectional view of an example of application of the sealing devices of FIGS. 1 and 2.

With reference to FIGS. 1 and 3, the reference number 1 designates as a whole a sealing device for a rolling-contact bearing 2.

The bearing 2 has an axis A of rotation and comprises an inner race 3 and an outer race 4, which are coaxial to one another and share the axis A itself, and are radially delimited, respectively outwards and inwards, by respective cylindrical surfaces 2s and 3s.

The bearing 2 moreover has two opposite axial sides L1 and L2, and the cylindrical surfaces 2s and 3s define, on each side L1 and L2, a respective annular window F1 and F2, which sets the outside and the inside of the bearing 2 itself in communication with one another.

The seal device 1 is mounted on the side L1 for closing the window F1 in order to prevent entry of contaminating agents into the bearing and exit of lubricating grease from said bearing 2 and comprises a shield 20 fitted on the inner race 3, a shield 30 fitted on the outer race 4 and made, like the shield 20, of metal material, and a single sealing lip 40, which is made of rubbery material, is fixed to the shield 30, and is set in sliding contact with the shield 20.

The shield 30 comprises a cylindrical wall 31 provided with an intermediate steplike formation 32, and a further cylindrical wall 33 provided with an rim 34 substantially having a toroidal shape bent radially inwards. The cylindrical wall 31 is fitted on the cylindrical surface 3s, and the steplike formation 32 identifies, on the cylindrical wall 31 itself, a fitting portion 31c set in direct contact with the cylindrical surface 3s, and a detached portion 31d, which is detached radially from the cylindrical surface 3s itself and is set axially towards the outside of the bearing 2 with respect to the portion 31c.

The cylindrical wall 33 is connected to the portion 31d of the cylindrical wall 31 by means of an intermediate turned-up element 35 bent to form a U, and is set in direct contact with the portion 31d itself, whilst the rim 34 supports the sealing lip 40, and terminates with a coaxial cylindrical surface 34s set facing the axis A.

The shield 20 comprises a respective cylindrical wall 21 fitted on the cylindrical surface 2s, a contact wall 22 fixed to the cylindrical wall 21, and a cylindrical edge 23, which is coaxial with respect to the cylindrical wall 21 and is fixed to the contact wall 22.

In particular, the cylindrical wall 21 has a front annular surface 21s set transverse to the axis A and facing outwards and towards the side L1 of the bearing 2, and is mounted on the inner race 3 so as to be axially aligned to the cylindrical wall 33 and to the toroidal rim 34, or, in other words, so as to present its surface 21s substantially aligned in an axial direction with respect to the turned-up element 35.

As has already been said, the contact wall 22 has a toroidal shape and is set about the axis A with its concavity facing towards the inside of the bearing 2. The wall 22 is moreover connected to the cylindrical wall 21 on the side axially opposite to the surface 21s by means of an intermediate turned-up element 25 bent to form a U, and detaches progressively in a radial direction outwards from the cylindrical wall 21 itself to terminate with a plane stretch 26, which is transverse to the axis A, and joins up with the edge 23, substantially forming a right angle.

The walls 21 and 22 and the edge 23 form between them an annular seat 27, which is delimited by the surface 21s and by the plane stretch 26 axially towards the outside and axially towards the inside of the bearing 2, respectively, and is delimited by the wall 21 and by the edge 23 radially towards the inside and radially towards the outside of the bearing 2 itself, respectively.

The sealing lip 40 is supported by the shield 30, extends in the direction of the shield 20 to set itself in sliding contact with the contact wall 22 so as to exert the above-mentioned sealing action, and comprises a basic static portion 40s fixed to the shield 30, and an elastic active portion 40a extending fixedly in series from the basic static portion 40s in contact with the shield 20.

The static portion 40s is anchored to the rim 34 and defines with the portion 40a an annular loop 41, which is set facing substantially in the direction of the shield 30 and has in a radial cross section a substantially circular shape. The elastic active portion 40a is fixed to the portion 40s itself and is free to bend and deform elastically against the contact wall 22 at the expense of the amplitude of the loop 41.

The sealing lip 40 further comprises four annular contacting sharp edges 42, 44, 46 and 48, which are arranged in series along the portion 40a, and are separated from one another by three coves 43, 45, and 47 open on the opposite side of the loop 41.

Each sharp edge 42, 44, 46, and 48 is set up against the contact wall 22, and is delimited by two respective annular surfaces converging towards one another and designated by 42e, 44e, 46e, and 48e, and, respectively, 42i, 44i, 46i, and 48i, of which the surfaces designated by the letter “e” face axially towards the outside of the bearing 2, whilst the surfaces designated by the letter “i” face axially towards the inside of the bearing 2.

In particular, the pairs of surfaces 42e and 44i, 44e and 46i, and 46e and 48i define between them the coves 43, 45, and 47, which are further delimited on their respective bottom by a wall 49 of connection between a sharp edge 42, 44, 46, and 48 and the adjacent sharp edge 44, 46, and 48. In order to bestow upon the sealing lip 40 the elastic characteristics necessary for ensuring tightness of the seal on the contact wall 22, the surface 42e and the surface 44i form between them an obtuse angle α, or in any case at least an angle of more than 90°, and the pairs of surfaces 44e and 46i, and 46e and 48i form between them respective angles β and γ at least greater than 90°.

The amplitude of the angles α, β, and γ consequently also affects the amplitude of the angles α′, β′, and γ′ subtended internally by the sharp edges 42, 44, and 48, respectively, but whilst the amplitude of the angles α, β, and γ can vary markedly according to the amount of the deformation of the sealing lip 40, the amplitude of the angles α′, β′, and γ′ are not affected by this deformation, in this way ensuring the correctness of the contact between the sharp edge and the contact wall 22.

Furthermore, for reasons that will be explained more fully in what follows, the sharp edge 42, i.e., the first sharp edge starting from the static portion 41s, subtends an angle α of amplitude greater than the amplitude of the angles subtended by the other sharp edges 44, 46 and 48, also as a result of a progressive reduction in thickness of the connection wall 49, which concurs also in the formation of the loop 41, and appears substantially curved at each cove 43, 45 and 47 and goes to zero at the last sharp edge 48 of the sealing lip 40.

The conformation of the wall 49, the amplitude of the angles α, β, and γ as well as also the dimensions of the sharp edges 42, 44, 46, and 48 unequivocally determine the elastic behaviour of the sealing lip sealing lip 40 and its corresponding sealing capacity. In fact, once the shield 30 is mounted with the wall 22 set in contact with the sealing lip 40, the elastic deformation of the sealing lip 40 itself causes the sharp edge 42 to exert a sealing action on the wall 22 directed in a radial direction substantially inwards, whilst the sharp edges 44, 46 and 48 exert a respective sealing action on the wall 22 directed in a radial direction substantially outwards, i.e., in a direction substantially opposite to the sealing action of the sharp edge 42.

On the other hand, the coves 43, 45 and 47 following upon the contact of the sharp edges 42, 44, 46 and 48 against the wall 22 tend to increase its corresponding amplitude, thus exerting an elastic action of return of the sharp edges 42, 44, 46, and 48 themselves towards one another.

Furthermore, the larger dimensions of the sharp edge 42 with respect to the dimensions of the sharp edges 44, 46, and 48, as well as the larger amplitude of the angle α with respect to the amplitude of the angles β and γ cause the sharp edge 42 itself, in response to the action of deformation of the wall 22, to exert on the entire portion 40a of the sealing lip 40 a twisting moment such as to increase the contact pressure of the other sharp edges 44, 46, and 48 enabling elimination of the spring referred to in the introduction.

In order to increase further the sealing capacity of the seal 1, the latter finally comprises a coating 60, which coats the rim 34, the wall 33, and the portion 31d, is made of the same material as the sealing lip 40, and has a cylindrical appendage 61 set substantially in a position corresponding to the turned-up element 35 to extend radially in the direction of the edge 23 and to form with the edge 23 itself a labyrinth seal.

From the above description it emerges clearly that the combination between the contact wall 22 having a toroidal shape and the single sealing lip 40 with the sharp edges 42, 44, 46, and 48, in addition to the particular geometrical conformation of the sealing lip 40 itself and of its coves 43, 45 and 47 enable not only guarantee of the necessary conditions of tightness both in regard to external contaminating agents and in regard to the lubricating grease inside the bearing 2, but also enable a reduction in the number of elements normally used for production of known sealing lips, amongst which the aforementioned spring, as well as any further secondary sealing lips, and in the production costs.

In addition, the absence of the aforesaid spring and the conformation described above of the sealing lip 40 determine an increase in the space axially available within the seal 1, with a consequent greater freedom of assembly between the two shields 20 and 30, at the same time guaranteeing, in any case, their relative arrangement.

The embodiment illustrated in FIG. 3 relates to a sealing device 1′ similar to the sealing device 1, from which the sealing device 1′ differs in so far as it is mounted on the side L2 for closing the window F2 and comprises a phonic wheel R integrated within the seat 27 for detecting the kinematic characteristics of the bearing 2.

In particular, the conformation of the seat 27 enables the adoption both of a phonic wheel R made of magnetized plastic materials and inserted within the seat 27 itself and the adoption of a phonic wheel R made of rubbery materials and co-moulded directly with the shield 20. In either case, the presence of the phonic wheel R does not jeopardize in the least the arrangement of relative assembly between the two shields 20 and 30 on account of the above-mentioned increase in the space axially available.

From the foregoing description, and from what is illustrated in FIG. 4, it may be deduced that the sealing device 1, and its variant 1′, are suitable for sealing either side L1 and L2 of the bearing 2 both in the case where it is necessary to provide a phonic wheel R and in the case where the presence of the phonic wheel R is not necessary.

In other words, the simultaneous adoption of the contact wall 22 having a toroidal shape and of the single sealing lip 40 described above enables standardization of the external dimensions of the sealing device 1 regardless of whether a phonic wheel R is present or not, with the undoubted advantage of a considerable simplification of the systems of assemblage, mounting, and checking of the bearings 3.

In conclusion, it should be emphasized that the actions exchanged between the sharp edges 42, 44, 46, and 48 and the wall 22 are exactly the same in the case where the sealing lip 40 is provided with the sharp edge 42 and with just one or just two sharp edges 44, 46, and 48. In other words, the sealing lip 40 described above has the same functions of sealing in regard to external agents and sealing in regard to the grease inside it also in the case where the number of the sharp edges 44, 46, and 48 is less than three as in the case illustrated, and is equal to one or else two.

It is understood that the invention is not limited to the embodiments described and illustrated herein, which are to be considered purely as examples of embodiment of the sealing device for rolling-contact bearings, which may instead undergo further modifications corresponding to shapes and arrangements of parts, details of construction and assembly.

1. A sealing device for rolling-contact bearings, the seal device being mounted between an outer race and an inner race of the bearing, and comprising a first shield fitted on the inner race, a second shield fitted on the outer race, and a seal element fixed to the second shield and set in sliding contact with the first shield; the sealing device being wherein the first shield comprises a contact wall having a toroidal shape set up against said seal element, which, in turn, comprises at least two annular contacting portions acting in substantially opposite radial directions, and is provided with a cove of separation between the at least two contacting portions, which is elastically deformable to increase a contacting action of the contacting portions themselves on the contact wall.

2. A sealing device according to claim 1, wherein said seal element is defined by a single sealing lip supported by the second shield.

3. A sealing device according to claim 2, wherein said single sealing lip comprises a static base portion, fixed to the second shield, and an elastic active portion, extending fixedly in series from the static base portion in contact with the first shield, a first contacting portion of said two contacting portions forming part of the elastic active portion and acting radially inwards on said contact wall.

4. A sealing device according to claim 3, wherein a second contacting portion of said two contacting portions forms part of the elastic active portion and is set in series with the first contacting portion, separated from the first contacting portion itself by means of said cove of separation, the second contacting portion acting radially outwards on said contact wall.

5. A sealing device according to claim 4, wherein said seal element comprises at least one further third contacting portion, which forms part of the elastic active portion, and is set in series with the second contacting portion, separated from the second contacting portion itself by means of a respective cove of separation, the third contacting portion acting on said contact wall in a direction concordant with the second contacting portion.

6. A sealing device according to claim 5, wherein said seal element comprises a fourth contacting portion, which forms part of the elastic active portion and is set in series with the third contacting portion, separated from the third contacting portion itself by means of a respective further cove of separation, the fourth contacting portion acting on said contact wall in a direction concordant with the third contacting portion.

7. A sealing device according to claim 6, wherein each said contacting portion is defined by a respective annular sharp edge,—which is set up against the contact wall and is delimited by a respective first annular surface and by a respective second annular surface converging in the direction of the corresponding first annular surface.

8. A sealing device according to claim 7, wherein the first annular surface of a contacting portion defines, with the second annular surface of the adjacent contacting portion, the corresponding cove of separation.

9. A sealing device according to claim 8, wherein the first annular surface of the first contacting portion and the second annular surface of the second contacting portion form between them an angle at least greater than 90°.

10. A sealing device according to claim 9, wherein the elastic active portion comprises a connection wall, which connects said contacting portions and delimits a bottom of each cove of separation.

11. A sealing device according to claim 10, wherein said connection wall has a thickness progressively decreasing starting from the basic static portion.

12. A sealing device according to claim 11, wherein the basic static portion and the elastic active portion define between them an annular loop open on the side opposite to said cove of separation and having in a radial cross section a substantially circular shape.

13. A sealing device according to, claim 1, wherein said first shield comprises a cylindrical wall, which is fitted on said inner race and is fixed to the contact wall to define with the contact wall itself a seat axially open on the opposite side of the sealing device element.

14. A sealing device according to claim 13, wherein it comprises a phonic wheel (R) integrated within said seat.

15. A sealing device according to claim 13, wherein it comprises a cylindrical wall fixed to said contact wall and set facing the second shield to form, with the second shield itself, a further seal at least to external agents.

16. A sealing device according to claim 15, wherein it comprises a cylindrical appendage directly facing said cylindrical wall to form a labyrinth seal with the cylindrical wall itself.
